(19) United States
(12) Patent Application Publication
(10) Pub. No.: US 2009/0073591 A1
(43) Pub. Date: Mar. 19, 2009

(54) COLOR WHEEL

(75) Inventor: Cheng-Hung Chou, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/946,470

(22) Filed: Nov. 28, 2007

(30) Foreign Application Priority Data
Sep. 19, 2007 (CN) 200710201774.0

(51) Int. Cl. G02B 7/00

(52) U.S. Cl. 359/892; 359/896

(57) ABSTRACT

An exemplary color wheel includes a motor, a color filter and a heat sink. The motor includes a main body, a rotary housing fixed to an end of the main body and a spindle extending outwardly from the rotary housing. The color filter is sleeved around the spindle of the motor. The heat sink is circumferentially positioned to the motor.

### BACKGROUND

1. Technical Field

The present invention relates to color wheels and, particularly, to a color wheel which can withstand high heat during rotation.

2. Description of Related Art

A color wheel for an optical device, such as a projection device, includes a color filter which is rotated at high speed by a motor for the separation of colors from a white light passing therethrough. The separated colors are then processed by another optical element of the projection device to produce a full color image.

Generally, a conventional color wheel comprises a motor and a color filter. The motor comprises a spindle extending outwardly therefrom. The color filter is sleeved around the spindle and fixed by adhesive.

In operation, the color wheel absorbs energy from the light passing therethrough and becomes hot. The longer the color wheel works, the hotter the color wheel becomes, and the faster the temperature of the color wheel rises. High temperatures can degrade the bonding properties of the adhesive between the color filter and the spindle. The color filter may shift, crack, or even separated from the spindle, particularly during high-speed rotation of the color wheel.

What is needed, therefore, is a color wheel which can withstand high heat during rotation.

### SUMMARY

In accordance with a present embodiment, a color wheel includes a motor, a color filter, and a heat sink. The motor includes a main body, a rotary housing fixed to an end of the main body, and a spindle extending outwardly from the rotary housing. The color filter is sleeved around the spindle of the motor. The heat sink is circumferentially positioned to the motor.

Other advantages and novel features will be drawn from the following detailed description of at least one preferred embodiment, when considered in conjunction with the attached drawings.

### BRIEF DESCRIPTION OF THE DRAWINGS

Many aspects of the present color wheel can be better understood with reference to the following drawings. The components in the drawings are not necessarily drawn to scale, the emphasis instead being placed upon clearly illustrating the principles of the present camera module. Moreover, in the drawings, like reference numerals designate corresponding parts throughout the several views.

FIG. 1 is an exploded, isometric view of a color wheel, according to a first present embodiment.

FIG. 2 is a side plan view of the color wheel of FIG. 1, but assembled and partially cut away.

FIG. 3 is a side plan view of a color wheel according to a second present embodiment, with a part thereof cut away.

FIG. 4 is a side plan view of a color wheel according to a third present embodiment, with a part thereof cut away.

FIG. 5 is a side plan view of a color wheel according to a fourth present embodiment, with a part thereof cut away.

### DETAILED DESCRIPTION OF THE PREFERRED EMBODIMENTS

Embodiments of the present color wheel will now be described in detail below and with reference to the drawings.

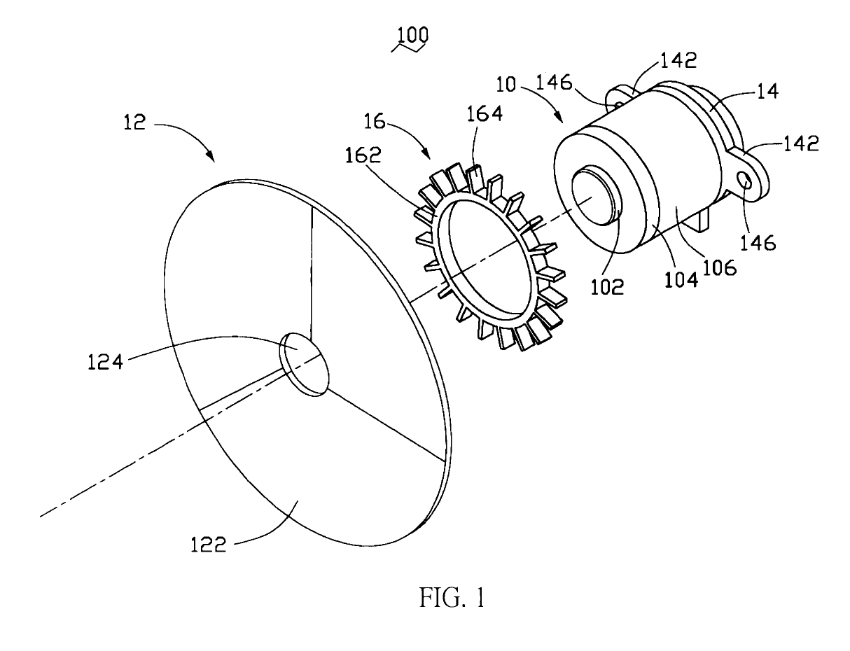

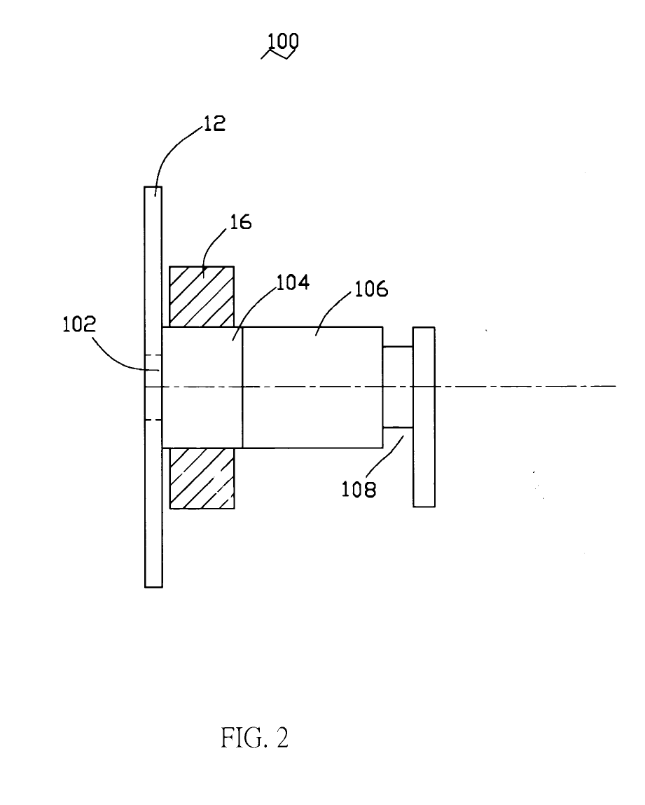

Referring to FIGS. 1-2, a color wheel 100 in accordance with a first present embodiment comprises a motor 10, a color filter 12, and a heat sink 16. The color filter 12 is positioned to the motor 10 by adhesive. The heat sink 16 is circumferentially positioned to the motor 10.

The color filter 12 comprises three filtering segments 122 in the embodiment and a central hole 124 encircled by the filtering segments 122.

The motor 10 comprises a main body 106, a rotary housing 104, and a spindle 102. The main body 106 defines an annular groove 108 therein at an end thereof. A fixing member 14 is positioned in the groove 108 for facilitating installation of the color wheel 100 in an optical device (not shown). The fixing member 14 comprises two symmetrical wings 142 and defines two through holes 146 in the wings 142 respectively. The rotary housing 104 is fixed to an opposite end of the main body 106 and carries the color filter 12 thereon by adhesive. The spindle 102 extends from the rotary housing 104 and is sleeved by the color filter 12.

The heat sink 16 comprises an annular loop 162 and a plurality of fins 164 extending outwardly from the loop 162. The loop 162 is sleeved around the rotary housing 104 of the motor 10 by adhesive or by any other suitable conventional means, for transferring heat from the rotary housing 104 to the fins 164. The fins 164 are separated from and parallel to each other. The fins 164 extend radially from an outer circumferential surface of the loop 162 in the embodiment. Other patterns of the fins 164 are feasible, for example, the fins 164 are spiraled on the outer circumferential surface of the loop 162, or each fin 164 encircles the loop 162. The fins 164 can be configured as square, triangle, or spiral etc. In practice, the fins 164 can be directly formed on the rotary housing 104 of the motor 10.

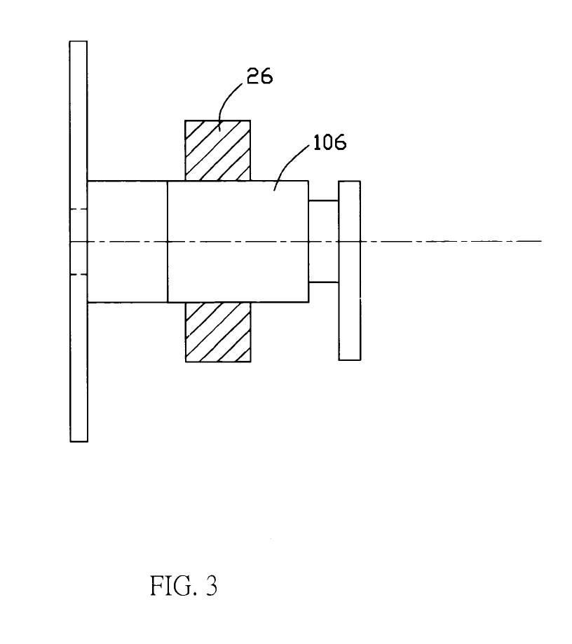

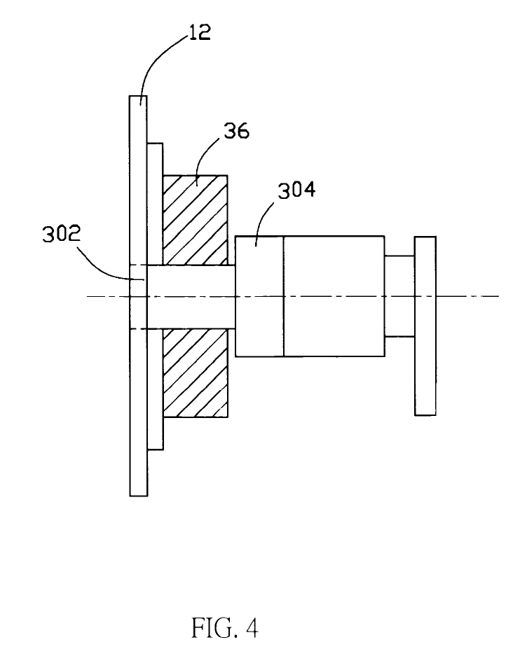

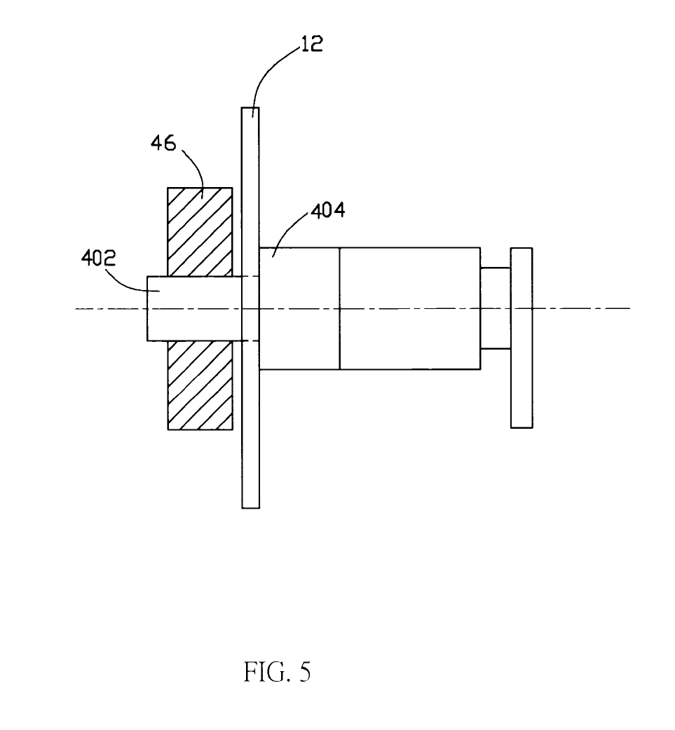

It is understood that the heat sink can also be positioned at other locations of the motor, such as the spindle or the main body. In FIG. 3, a heat sink 26 is positioned to the main body 106. In FIG. 4, a heat sink 36 is positioned to a spindle 302 and disposed between a rotary housing 304 and the color filter 12. In FIG. 5, a heat sink 46 is positioned to a spindle 402 and the color filter 12 is disposed between the heat sink 46 and a rotary housing 404.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A color wheel comprising:
a motor comprising a main body, a rotary housing fixed to an end of the main body and a spindle extending outwardly from the rotary housing;
a color filter sleeved around the spindle of the motor; and
a heat sink circumferentially positioned to the motor.

2. The color wheel as claimed in claim 1, wherein the heat sink is positioned to the rotary housing of the motor.

3. The color wheel as claimed in claim 2, wherein the color filter is positioned to the rotary housing of the motor.

4. The color wheel as claimed in claim 1, wherein the heat sink comprises an annular loop sleeved around the motor and a plurality of fins extending outwardly from the loop.

5. The color wheel as claimed in claim 4, wherein the fins extend radially from an outer circumferential surface of the loop.

6. The color wheel as claimed in claim 4, wherein the fins are separated from and parallel to each other.

7. The color wheel as claimed in claim 1, wherein the heat sink is positioned to the spindle of the motor.

8. The color wheel as claimed in claim 7, wherein the heat sink is disposed between the rotary housing and the color filter.

9. The color wheel as claimed in claim 7, wherein the color filter is disposed between the rotary housing and the heat sink.

10. The color wheel as claimed in claim 1, wherein the heat sink is positioned to the main body of the motor.

11. The color wheel as claimed in claim 1, wherein a fixing member is positioned to an opposite end of the main body for facilitating installation of the color wheel.

12. The color wheel as claimed in claim 11, wherein the fixing member comprises two wings and defines two through holes in the wings respectively.
